(19) United States
(12) Patent Application Publication
(10) Pub. No.: US 2022/0297605 A1
(43) Pub. Date: Sep. 22, 2022

(54) DISPLAY OF A VEHICLE ENVIRONMENT FOR MOVING THE VEHICLE TO A TARGET POSITION

(71) Applicant: Valeo Schalter und Sensoren GmbH, Bietigheim-Bissingen (DE)

(72) Inventors: Stefan Ewald, Bietigheim-Bissingen (DE); Stefanie Prinzhausen, Bietigheim-Bissingen (DE)

(73) Assignee: Valeo Schalter und Sensoren GmbH, Bietigheim-Bissingen (DE)

(21) Appl. No.: 17/639,701

(22) PCT Filed: Sep. 1, 2020
(86) PCT No.: PCT/EP2020/074273

§ 371 Date: Mar. 2, 2022

(30) Foreign Application Priority Data
Sep. 5, 2019 (DE) 10 2019 123 778.5

(51) Int. Cl. B60R 1/27; B60R 11/04; G06V 20/58

(52) U.S. Cl. CPC B60R 1/27; B60R 11/04; G06V 20/586; B60R 2300/105; B60R 2300/301; B60R 2300/303; B60R 2300/308; B60R 2300/607; B60R 2300/806; B60R 2300/8093

(57) ABSTRACT

The invention relates to a method for: displaying an environment (16) of a vehicle (10), the vehicle (10) having a camera-based environment detection system (14) for detecting the environment (16) of the vehicle (10); and moving the vehicle (10) to a target position (24) in the environment (16). The method comprises the steps: providing images of the environment (16) of the vehicle (10) using the camera-based environment detection system (14); generating a bird's eye view of an environment image (26) based on the images of the environment (16) of the vehicle (10) provided using the camera-based environment detection system (14); determining at least one target position (24) in the environment (16) of the vehicle (10); displaying the at least one target position (24) in a first superimposition plane which covers the environment (16) of the vehicle (10); and superimposing the first superimposition plane on the environment image (26). The invention also relates to a corresponding driving assistance system (10) designed to perform the above method.

The present invention relates to a method for representing a surround of a vehicle, the vehicle having a camera-based surround capture system for capturing the surround of the vehicle for the purposes of moving the vehicle to a target position in the surround.

Additionally, the present invention relates to a driver assistance system for representing a surround of a vehicle, comprising a camera-based surround capture system for capturing the surround of the vehicle and a processing unit which receives images of the surround of the vehicle, the driver assistance system being designed to carry out the aforementioned method.

Various assistance functions or else general driver assistance systems for moving a vehicle to a target position are known. By way of example, this relates to parking of vehicles in a parking space in the surround, the parking space representing the target position. Thus, appropriate assistance systems may register a surround of the vehicle, for example, in order to assist with the identification of parking spaces or other target positions. Furthermore, these systems may assist in the determination of an optimal trajectory which a vehicle driver can follow in order to park the vehicle in a parking space or to reach any desired target position.

Moreover, autonomous or partly autonomous parking, for example, are important functions in current vehicles, and already find use in these vehicles in various driver assistance systems and simplify parking. In the process, the respective vehicle is maneuvered autonomously or partly autonomously to a detected parking space. In so doing, the vehicle driver may be allowed to already leave the vehicle before the parking process is carried out. By way of example such functions are known for the purposes of autonomously parking the vehicle in a private garage or on any private parking space after occupants have left the vehicle.

In metropolitan areas, in particular, parking spaces are frequently rare, and parking and leaving may be time consuming. Therefore, further improvements within the scope of parking vehicles are desirable.

To move the vehicle to a target position, it is often helpful to visualize details regarding the movement of the vehicle to the target position for a vehicle driver. This may increase trust in the autonomous or partly autonomous movement of the vehicle and hence significantly improve the acceptance of these functions. A user interface of the vehicle with a visual display unit, which is usually situated within the vehicle, is used to represent the details regarding the movement of the vehicle to the target position, in particular to a parking space in the surround of the vehicle. In this context, it is important that the vehicle driver can compare the representation of the details as easily as possible with their own perception of the surround of the vehicle.

Various concepts are known here for representing the details regarding the movement of the vehicle to the target position. For example, an artificially generated vehicle surround including details regarding the movement of the vehicle to the target position may be represented. To this end, use is typically made of a schematic representation which only has little correspondence with the real surround as perceived by the vehicle driver.

In principle, representations with a 360° view from a bird's eye perspective with real camera images are also known. These representations are based on a camera-based surround capture system which carries out a 360° capture of the surround. By way of example, such camera-based surround capture systems comprise a surround-view camera system with four cameras attached to the vehicle. However, there is a distortion of the real surround of the vehicle in the process, making a comparison with the real surround more difficult. In principle, comparable representations in the style of a bowl view or an adaptive bowl view, which partly reduce these problems, are also known. Overall, there still is a need for improvements in the representation of relevant information regarding the movement of the vehicle to the target position.

From DE 103 17 044 A1, it is known that motor vehicle drivers often find it difficult in the case of difficult driving maneuvers to estimate the trajectory their vehicle will travel and the clearance required to avoid collisions. This is particularly the case when the vehicle driver is not familiar with the dimensions of the vehicle or its driving behavior. Image data of the vehicle surround located in the area of the driving direction are recorded by means of a camera system within the scope of a method for monitoring the clearance in the driving direction of the vehicle. Additionally, the clearance required for unimpeded movement is calculated in advance within a signal processing unit on the basis of the operational parameters and the dimensions of the vehicle. At least some of the image data relating to the required clearance, which were captured by the camera system, are displayed to the motor vehicle driver on a display. The image data associated with the required clearance are subjected to further processing, the vehicle driver being informed as a result of this further processing as to whether or not sufficient clearance is available for unimpeded movement. Thus, continuous evaluation of the image data renders it possible to automatically react even to a dynamic change in the vehicle surround and inform the vehicle driver as to whether or not sufficient clearance is available for unimpeded movement.

DE 10 2011 082 483 A1 relates to a method for assisting a motor vehicle driver with a driving maneuver, said method comprising the following steps: a) registering data of the surround of the motor vehicle, evaluating the registered data for registering objects and optical representation of the registered objects, b) selecting at least one of the registered objects by the motor vehicle driver, c) determining the shortest distance between the motor vehicle and the at least one selected object, and d) outputting information for the motor vehicle driver about the shortest distance between the at least one selected object and the motor vehicle.

US 2015/0098623 A1 relates to an image processing apparatus which draws a virtual three-dimensional space, in which a surrounding region around an automobile is reconstructed, on the basis of an image taken by a camera installed in the automobile and the distance to a measurement point on a peripheral object, as calculated by a rangefinder installed in the automobile. The image processing apparatus comprises: an outline computation unit configured to compute an outline of an intersection plane between a plurality of grid planes defined in a predetermined coordinate system and the peripheral object; and an image processing unit configured to draw the outline computed by the outline computation unit on a corresponding peripheral object arranged in the virtual three-dimensional space; and the plurality of grid planes are configured with planes which are perpendicular to an X-axis, a Y-axis and a Z-axis in the predetermined coordinate system, respectively.

Proceeding from the aforementioned prior art, the invention is therefore based on the object of specifying a method of representing a surround of a vehicle, the vehicle having a camera-based surround capture system for capturing the surround of the vehicle for the purposes of moving the vehicle to a target position in the surround, and a corresponding driver assistance system, which facilitate simple movement of the vehicle to the target position in the surround of the vehicle.

The object is achieved according to the invention by the features of the independent claims. Advantageous embodiments of the invention are specified in the dependent claims.

According to the invention, a method of representing a surround of a vehicle is consequently specified, the vehicle having a camera-based surround capture system for capturing the surround of the vehicle for the purposes of moving the vehicle to a target position in the surround, the method comprising the steps of providing images of the surround of the vehicle using the camera-based surround capture system, generating a surround image from a bird's eye view on the basis of the images of the surround of the vehicle that were provided by the camera-based surround capture system, determining at least one target position in the surround of the vehicle, representing the at least one target position in a first overlay plane which covers the surround of the vehicle, and overlaying the first overlay plane on the surround image.

Moreover, a driver assistance system for representing a surround of a vehicle is specified according to the invention, comprising a camera-based surround capture system for capturing the surround of the vehicle and a processing unit which receives images of the surround of the vehicle, the driver assistance system being designed to carry out the aforementioned method.

Thus, the basic concept of the present invention is that of obtaining an improvement in the movement of vehicles to a target position by virtue of implementing a representation of target information, for example a target position in the surround of the vehicle, as intuitively as possible such that a vehicle driver is put into a position of being able to reliably process the target information in a short amount of time. To this end, the present method facilitates a representation which firstly is realistic and has a high degree of optical correspondence with the surround of the vehicle as also perceived by the vehicle driver and which secondly provides additional information in the form of a first overlay plane on the basis of a processing of sensor information relating to the surround of the vehicle. As a result, the additional information can simply be represented by virtue of appropriately overlaying the information from the first overlay plane on the surround image in the bird's eye view.

In principle, the vehicle can be any desired vehicle. The vehicle is preferably designed for autonomous or partly autonomous maneuvering for the purposes of moving to the target position, especially for parking the vehicle. In so doing, the vehicle driver may be allowed to already leave the vehicle before a movement to the target position is carried out.

The driving assistance system provides a driver assistance function or more generally a driving assistance function. By way of example, a surround of the vehicle can be captured by the driver assistance function in order to determine at least one target position and optionally to determine an optimal trajectory which a vehicle driver can follow in order to move the vehicle to the target position.

Depending on the type of driving assistance system, the target position may be for example a parking space for parking the vehicle. In the case of valet parking, the target position may be a handover point for handing the vehicle over to the valet. In other driving assistance systems, for example automatic parking in a garage, the target position may be defined by the garage. In the case of learned parking, the target position may be any learned parking position which is independent of a specified parking space. This is an exemplary, non-exhaustive list of possible target positions.

The surround relates to an area around the vehicle. This usually means an area within a detection range of surround sensors of the vehicle, that is to say an area within a radius of for example 5-50 meters about the vehicle, preferably within a radius of no more than approximately 20 meters. Moreover, the range may be extended therebeyond as a matter of principle by way of sensor information received and stored in advance by the surround sensors.

The representation of the surround of the vehicle comprises an output of information by way of a graphical user interface in the vehicle, for example with a visual display unit, preferably with a touch-sensitive visual display unit to additionally receive input from the vehicle driver.

The camera-based surround capture system facilitates a 360° capture of the surround. By way of example, such camera-based surround capture systems comprise a surround-view camera system with four cameras attached to the vehicle, that is to say each side of the vehicle has one of the cameras attached thereto. The cameras are preferably wide-angle cameras with a aperture angle of approximately 170°-180°. These four cameras can provide four images in each case, the images together completely covering the surround of the vehicle, that is to say facilitating a 360° view. Accordingly, images of the surround of the vehicle from the camera-based surround capture system are initially provided as a plurality of individual images.

Consequently, the generation of a bird's eye view surround image typically comprises a processing of the plurality of individual images provided together by the camera-based surround capture system. The images are processed and/or combined appropriately in order to generate the 360° view.

At least one target position in the surround of the vehicle can be determined in different ways. To this end, sensor information can be processed directly in order to determine the at least one target position. Alternatively or in addition, a surround map, for example, may initially be generated on the basis of the sensor information and the at least one target position is then determined on the basis thereof. By way of example, the determination of the target position may comprise an identification of a parking space on the basis of line markings, traffic signs or other identifiers, an identification of a handover point to the valet or an identification of a garage.

Representing the at least one target position in the first overlay plane relates to a representation of the target position for the movement of the vehicle. The target position is preferably represented by a boundary line which completely or partly surrounds the target position. In principle, the target position may also be represented by an area that is colored differently or by a contour line with outlines of the own vehicle which should be moved to the target position. The target position may be an exact position or for example define a window into which the vehicle is moved. Accordingly, the representation of the respective target position in the first overlay plane can be implemented in fundamentally different ways.

By overlaying the first overlay plane on the surround image there is a combined representation of the surround image, as perceived by the vehicle driver, and the target information, which represents a target position in the surround of the vehicle in this case. In this case, overlaying means that available parts of the surround image are replaced or complemented by the overlay plane, for example by way of a partly transparent overlay. In this case, it is not necessary for the overlay image to completely fill an image area; this is also not possible for example when parts of the surround are shadowed by obstacles. The surround image might also only be complemented with image information from the first overlay plane.

In an advantageous embodiment of the invention, the method comprises the following additional steps: establishing a non-drivable area in the surround of the vehicle, representing the non-drivable area in a second overlay plane which covers the surround of the vehicle, and overlaying the second overlay plane on the surround image. The non-drivable area can either be established directly or it is possible to initially establish a drivable area, and the non-drivable area is established by inverting the drivable area. The second overlay plane represents an additional overlay plane to the first overlay plane, the overlay planes in principle being able to be used in any sequence to be overlaid on initially the surround image and optionally the respective other overlay plane. The explanations given above in relation to the surround image being overlaid by the first overlay plane apply accordingly.

In an advantageous embodiment of the invention, the representation of the non-drivable area in a second overlay plane which covers the surround of the vehicle comprises a generation of a representation of the non-drivable area in a side view on the basis of the images of the surround of the vehicle that were provided by the camera-based surround capture system. Such a side view corresponds to a representation as is used in an adaptive bowl view, for example. The side view facilitates a high recognition value of the surround in the surround image. Here, the side view is preferably generated without distortions or at least with reduced distortions, for the purposes of which appropriate image processing of the images from the camera-based surround capture system is carried out.

In an advantageous embodiment of the invention, the method comprises the following additional steps: establishing at least one obstacle in the surround of the vehicle, representing the at least one obstacle in a third overlay plane which covers the surround of the vehicle, and overlaying the third overlay plane on the surround image. The at least one obstacle can be established directly on the basis of sensor information. Alternatively or in addition, a surround map, for example, may be generated on the basis of the sensor information and said surround map serves as a basis for establishing the at least one obstacle. The third overlay plane represents an additional overlay plane to the first and optionally the second overlay plane, the overlay planes in principle being able to be used in any sequence to be overlaid on initially the surround image and optionally the other overlay plane(s). The explanations given above in relation to the surround image being overlaid by the first overlay plane apply accordingly.

In an advantageous embodiment of the invention, the representation of the at least one obstacle in a third overlay plane comprises a representation of boundaries of the at least one obstacle. The at least one obstacle is preferably represented by a boundary line, which completely or partly surrounds the at least one obstacle. In principle, the at least one obstacle may also be represented by an area that is colored differently or else represented differently.

In an advantageous embodiment of the invention, the method comprises a step for identifying the at least one obstacle, and the representation of the at least one obstacle in a third overlay plane which covers the surround of the vehicle comprises a representation of the at least one obstacle on the basis of the identification of the at least one obstacle. The identification of the at least one obstacle relates to a classification, for example in order to identify third-party vehicles, trees, persons, buildings, garbage cans or other obstacles. On the basis thereof, a representation of the obstacle can be chosen in correspondence with the respective class. That is to say, a type of place holder for the at least one obstacle is selected on the basis of the identification and represented in the third overlay plane. In this case, the obstacle is preferably represented in a top view in correspondence with the representation of the surround image. Alternatively, the obstacle can be represented in a side view.

In an advantageous embodiment of the invention, the representation of the at least one obstacle in a third overlay plane which covers the surround of the vehicle comprises a provision of a camera image of the at least one obstacle. The camera image facilitates a particularly realistic representation of the at least one obstacle, as a result of which a simple assignment of the representation to the surround as perceived by the vehicle driver is facilitated. In this case, the camera image is preferably generated in a top view in correspondence with the representation of the surround image, or the camera image is projected into the top view.

In an advantageous embodiment of the invention, the representation of the at least one obstacle in a third overlay plane which covers the surround of the vehicle comprises a distance-dependent representation of the at least one obstacle. In particular, the distance-dependent representation comprises a representation of the obstacle or regions of the obstacle in different colors depending on the distance. Thus, close obstacles may be represented using a red color, for example, while distant obstacles can be represented using a green color or using a black or gray color, for example. Such a representation lends itself especially to regions that are no longer actively registered by the surround sensors. This can indicate to the user that this region was previously registered by one of the surround sensors but there no longer is active registration. Additionally, close regions of an obstacle can be represented using a different color to distant regions of the obstacle, for example. Instead of a uniform color, they can also be a colored representation with a color gradation or a colored pattern.

In an advantageous embodiment of the invention, the representation of the at least one obstacle in a third overlay plane which covers the surround of the vehicle comprises a generation of a representation of the at least one obstacle in a side view on the basis of the images of the surround of the vehicle that were provided by the camera-based surround capture system. Such a side view corresponds to a representation as is used in an adaptive bowl view, for example. The side view facilitates a high recognition value of the obstacle in the surround image. Here, the side view is preferably generated without distortions or with reduced distortions, for the purposes of which appropriate image processing of the images from the camera-based surround capture system is required.

In an advantageous embodiment of the invention, the determination of at least one target position in the surround of the vehicle and/or the determination of a non-drivable area in the surround of the vehicle and/or the establishment of the at least one obstacle in the surround of the vehicle is implemented taking account of the images of the surround of the vehicle that were provided by the camera-based surround capture system. The camera-based sound capture system therefore serves as surround sensor for monitoring the surround of the vehicle. In principle, no further surround sensors are required as a result, but then they can be used to improve the monitoring.

In an advantageous embodiment of the invention, the method comprises a step for receiving sensor information from at least one further surround sensor, in particular a lidar-based surround sensor, a radar sensor or a plurality of ultrasound sensors, which registers at least a portion of the surround of the vehicle, and the determination of at least one target position in the surround of the vehicle and/or the determination of a non-drivable area in the surround of the vehicle and/or the establishment of the at least one obstacle in the surround of the vehicle is implemented taking account of the sensor information of the at least one further surround sensor. By way of a suitable selection of surround sensors, which may be attached to the vehicle in any combination and number, a particularly reliable registration of the surround of the vehicle is consequently facilitated, in order to determine or register a target position, the non-drivable area and/or the at least one obstacle. In this case, the camera-based surround capture system may provide additional sensor information which is processed together with the sensor information of the at least one further surround sensor in order to determine or register the at least one target position, the non-drivable area and/or the at least one obstacle. Alternatively, it is only the sensor information from the at least one further surround sensor that is used. When a plurality of similar and/or different surround sensors are used, there can be a fusion of the sensor information from the surround sensors.

In an advantageous embodiment of the invention, the generation of a surround image from a bird's eye view on the basis of the images of the surround of the vehicle that were provided by the camera-based surround capture system comprises a generation of a bowl view-type surround image. This is a special view in the style of a bowl, in which the edges are pulled upward. In contrast to a representation from a bird's eye view, the edges can therefore be represented partly in a side view. Compared to a pure top view or bird's eye view, this improves the correspondence with the surround as perceived by the vehicle driver, especially in distant areas.

In an advantageous embodiment of the invention, the representation of the at least one target position in a first overlay plane which covers the surround of the vehicle comprises a representation of a trajectory for moving the vehicle to reach the target position. The trajectory allows the movement to reach the target position to be estimated well. In particular, it is already possible to check in advance whether the vehicle can even be moved to the target position. The trajectory may comprise multiple moves with driving direction reversal.

In an advantageous embodiment of the invention, the representation of the trajectory for moving the vehicle to reach the target position comprises a representation of an area the vehicle passes over when driving along the trajectory. Depending on the drivable area, it is hence possible to easily determine whether there is a risk of leaving the drivable area. The area the vehicle passes over when driving along the trajectory is preferably represented on the basis of the dimensions of the respective vehicle that comprises the driving assistance system. Alternatively, it is possible to use a mean value or a maximum value for conventional vehicles as corresponding dimensions of the vehicle.

Alternatively or in addition, it is possible to represent additional target information, for example stop points along the trajectory, a speed profile when driving along the trajectory, with a current speed preferably being encoded by means of different colors, an actuation of an access restriction (garage door, garden gate, (lowerable) bollards, bars) when driving on the trajectory, or others.

In an advantageous embodiment of the invention, the method comprises the step for storing the images of the surround of the vehicle that were provided by the camera-based surround capture system and the generation of a surround image in a bird's eye view comprises a generation of at least one first area of the surround image on the basis of images of the surround of the vehicle currently provided by the camera-based surround capture system and at least one second area with stored images of the surround of the vehicle. Hence, it is possible to cover a larger area around the vehicle in relation to the use of only current images, with a currentness of the stored images naturally needing to be taken into account. The determination of the at least one target position in the surround of the vehicle can likewise be performed on the basis of the current images of the surround of the vehicle that were provided by the camera-based surround capture system in combination with stored images. A corresponding statement applies to the establishment of the obstacles in the surround. In this case, the surround image may have a different representation of the at least one first area and the at least one second area in order to indicate a potential risk of change in the second area proceeding from the stored images. By way of example, the first and second area may be stained differently (red, gray).

The invention is explained in more detail below with reference to the attached drawing and on the basis of preferred embodiments. The illustrated features may represent an aspect of the invention both individually and in combination. Features of different exemplary embodiments may be transferred from one exemplary embodiment to another.

In the drawings:

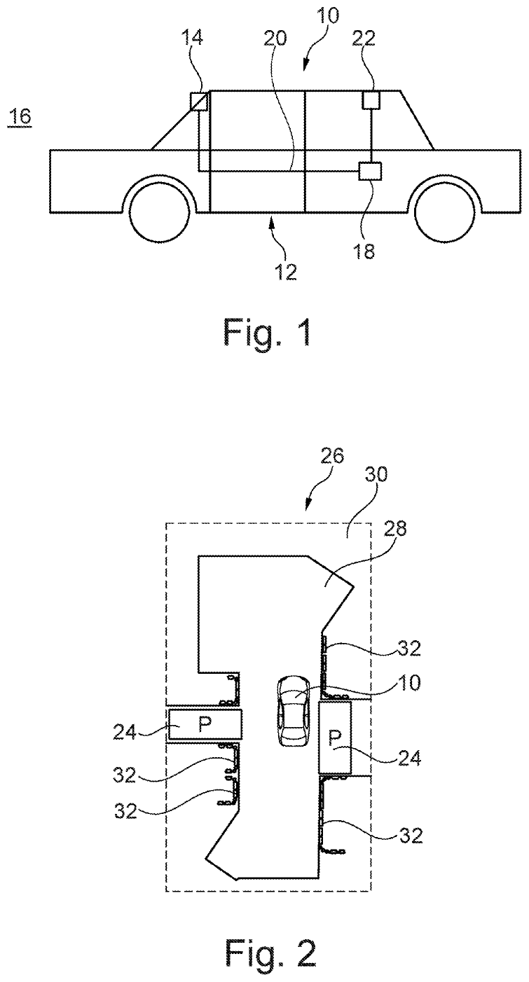

FIG. 1 shows a schematic depiction of a vehicle with a driving assistance system according to the first, preferred embodiment in a side view,

FIG. 2 shows a first exemplary depiction of the vehicle with the surround around the vehicle in correspondence with the first embodiment,

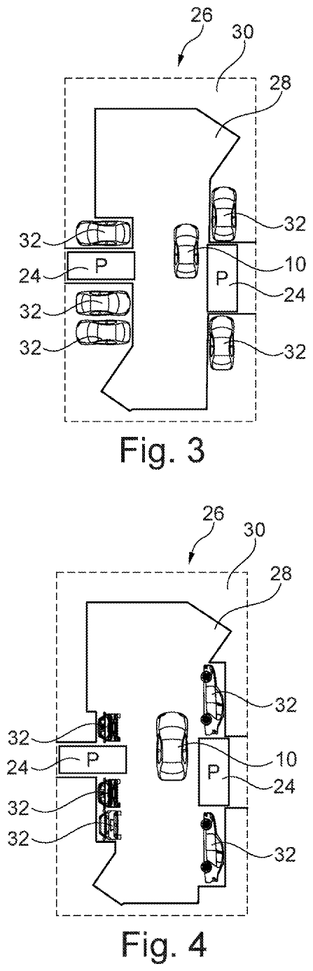

FIG. 3 shows a second exemplary depiction of the vehicle with the surround around the vehicle in correspondence with a second embodiment,

FIG. 4 shows a third exemplary depiction of the vehicle with the surround around the vehicle in correspondence with a third embodiment,

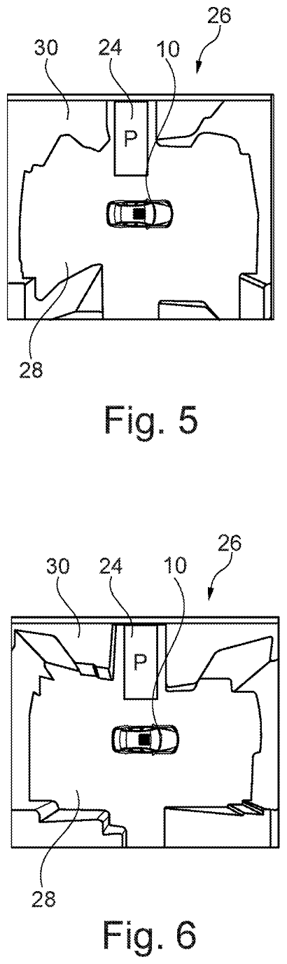

FIG. 5 shows a fourth exemplary depiction of the vehicle with the surround around the vehicle in the style of a bowl view and in correspondence with a fourth embodiment,

FIG. 6 shows a fifth exemplary depiction of the vehicle with the surround around the vehicle in the style of an adaptive bowl view and in correspondence with a fifth embodiment, and

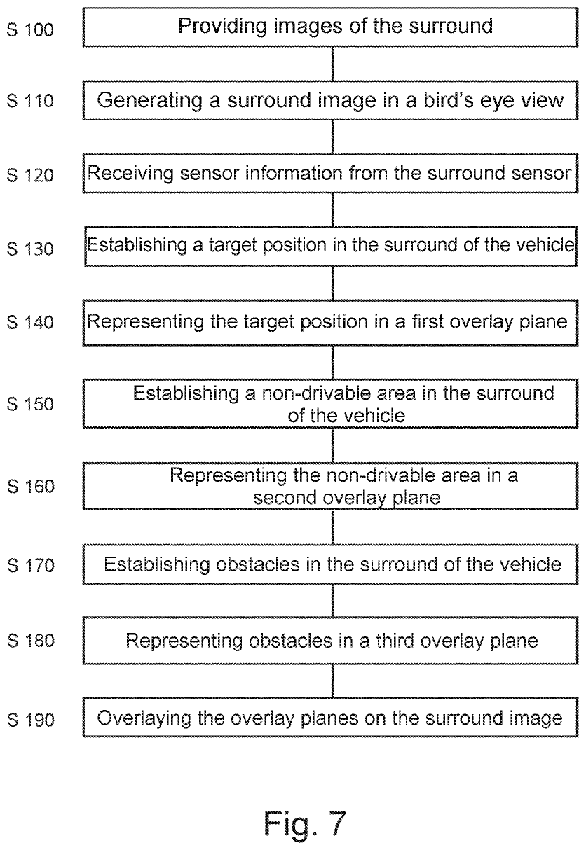

FIG. 7 shows a flowchart of a method for representing the surround of the vehicle from FIG. 1 in correspondence with the vehicle and the driving assistance system of the first exemplary embodiment.

FIG. 1 shows a vehicle 10 with a driving assistance system 12 according to a first, preferred embodiment. In principle, the vehicle 10 is any vehicle 10, which is preferably designed for autonomous or partly autonomously maneuvering, for example for parking the vehicle 10. In the case of autonomous driving, the vehicle driver is allowed to already leave the vehicle 10 before a corresponding parking process is carried out.

The driver assistance system 12 comprises a camera-based surround capture system 14 which carries out a 360° capture of a surround 16 of the vehicle 10. In this exemplary embodiment, the camera-based surround capture system 14, presented here for simplicity as an individual device, comprises four individual surround view cameras, which are not depicted individually in the figures and which are attached to the vehicle 10. In detail, one of the four cameras is attached to each side of the vehicle 10. The four cameras are preferably wide-angle cameras with an aperture angle of approximately 170°-180°. The four cameras provide four images in each case, the images together completely covering the surround 16 of the vehicle 10, that is to say facilitating a 360° view.

The driving assistance system 12 furthermore comprises a processing unit 18 which receives images from the camera-based surround capture system 14 via a data bus 20.

Moreover, the driving assistance system 12 comprises a surround sensor 22, which is in the form of a radar sensor or lidar-based sensor in this exemplary embodiment. The surround sensor 22 transfers sensor information relating to the surround 16 of the vehicle 10 to the processing unit 18 via the data bus 20. In an alternative embodiment, the surround sensor 22 is designed as an ultrasound sensor unit with a plurality of individual ultrasound sensors.

The driving assistance system 12 represents a driver assistance function or, in general, a driving assistance function, wherein the surround 16 of the vehicle 10 is registered in order to assist with the determination of target positions 24 and optionally to determine an optimal trajectory which a vehicle driver can follow in order to move the vehicle 10 to the target position 24.

Accordingly, the driving assistance system 12 in this exemplary embodiment is designed to carry out a method of representing the surround 16 of the vehicle 10 in order to move the vehicle 10 to a target position 24 in the surround 16. The method is reproduced in FIG. 7 as a flowchart and is described below with additional reference to FIGS. 2 to 6. FIGS. 2 to 6 represent different representations of the surround 16 of the vehicle 10, which can all be generated with the same driving assistance system 12. A change in the representation merely requires an altered configuration or programming of the driving assistance system 12. The driving assistance system 12 in the first exemplary embodiment is designed for autonomous parking of the vehicle 10.

Accordingly, the target position 24 in this exemplary embodiment is a parking space 24 for parking the vehicle 10.

The method starts with step S100, which comprises a provision of images of the surround 16 of the vehicle 10 by means of the camera-based surround capture system 14. The four individual images are in each case transmitted together via the data bus 20 to the processing unit 18 of the driving assistance system 12.

Step S110 relates to a generation of a surround image 26 from a bird's eye view on the basis of the images of the surround 16 of the vehicle 10 that were provided by the camera-based surround capture system 14. Accordingly, the surround image 26 is generated from processing the individual images which are provided together by the camera-based surround capture system 14. The individual images are processed and/or combined appropriately in order to generate the 360° view. A corresponding representation with the surround image 26 in the bird's eye view is shown in FIGS. 2 to 4.

In an alternative, fourth embodiment, which is depicted in FIG. 5, the surround image 26 is generated in the style of a bowl view. The bowl view relates to a special view in the style of a bowl, in which the edges are pulled upward such that, in contrast to a representation in the bird's eye view, edges are represented at least partially in a side view. Consequently, the representation of the surround image 26 is implemented in the style of a bowl view.

In an alternative, fifth embodiment, which is depicted in FIG. 6, the surround image 26 is generated in the style of an adaptive bowl view.

Step S120 relates to a reception of sensor information from the surround sensor 22, which registers at least a portion of the surround 16 of the vehicle 10. The sensor information of the surround sensor 22 is transferred to the processing unit 18 via the data bus 20.

Step S130 relates to a determination of at least one target position 24 in the surround 16 of the vehicle 10. In this exemplary embodiment, the determination of the at least one target position 24 relates to the establishment of a parking space as a target position 24. In this exemplary embodiment, the at least one target position 24 is determined with taking account of the sensor information from the surround sensor 22 together with the sensor information from the camera-based surround capture system 14, that is to say the images provided by the camera-based surround capture system 14. The sensor information from the surround sensor 22 and the camera-based surround capture system 14 is processed together in order to register the at least one parking space 24. In the process, fusion of the sensor information of the surround sensor 22 and the camera-based surround capture system 14, optional per se, is carried out.

The at least one parking space 24 in the surround 16 of the vehicle 10 can be established in different ways. To this end, the sensor information from the surround sensor 22 can be processed directly together with the sensor information from the camera-based surround capture system 14, in order to determine the at least one parking space 24. Alternatively or in addition, a surround map may be generated on the basis of the sensor information and said surround map serves as a basis for establishing the parking space 24.

Step S140 relates to a representation of the at least one target position 24, that is to say the at least one parking space 24, in a first overlay plane, which covers the surround 16 of the vehicle 10. Representing the at least one parking space 24 in the first overlay plane relates to a representation of the parking space 24 for parking the vehicle 10. In this exemplary embodiment, the parking space 24 is represented by a boundary line, which completely surrounds the parking space 24. Alternatively or in addition, the parking space 24 can be represented by an area that is colored differently.

Step S150 relates to an establishment of a non-drivable area 30 in the surround 16 of the vehicle 10. The non-drivable area 30 can either be established directly or it is possible to initially establish a drivable area 28, and the non-drivable area 30 is established by inverting the drivable area 28.

The non-drivable area 30 in the surround 16 of the vehicle 10 is also established with taking account of the sensor information from the surround sensor 22 together with the sensor information from the camera-based surround capture system 14, that is to say the images provided by the camera-based surround capture system 14. The sensor information from the surround sensor 22 and the camera-based surround capture system 14 is processed together in order to register the non-drivable area 30. In the process, fusion of the sensor information of the surround sensor 22 and the camera-based surround capture system 14, optional per se, is carried out.

The non-drivable area 30 in the surround 16 of the vehicle 10 can be established in different ways. To this end, the sensor information from the surround sensor 22 can be processed directly together with the sensor information from the camera-based surround capture system 14, in order to determine the non-drivable area 30. Alternatively or in addition, a surround map may be generated on the basis of the sensor information and said surround map serves as a basis for establishing the non-drivable area 30.

Step S160 relates to a representation of the non-drivable area 30 in a second overlay plane which covers the surround 16 of the vehicle 10. The second overlay plane represents an additional overlay plane to the first overlay plane. In the representations of FIGS. 2 to 4, the non-drivable area 30 is marked by a uniform area with a given color such that the surround image 26 is overlaid by this area in the non-drivable area 30 and cannot be perceived.

In the fourth or fifth embodiment, depicted accordingly in FIGS. 5 and 6, a side view on the basis of the images of the surround 16 of the vehicle 10 that were provided by the camera-based surround capture system 14 is generated for representing the non-drivable area 30. In this case, the side view is preferably generated dynamically and adapted continuously. Such a side view corresponds to a representation as is used, for example, in a bowl view, as illustrated in FIG. 5, or an adaptive bowl view, which is illustrated in FIG. 6. In the adaptive bowl view, the side view is generated with reduced distortions, for the purposes of which appropriate image processing of the images from the camera-based surround capture system 14 is implemented.

Step S170 relates an establishment of at least one obstacle 32 in the surround 16 of the vehicle 10.

The at least one obstacle 32 in the surround 16 of the vehicle 10 is also established with taking account of the sensor information from the surround sensor 22 together with the sensor information from the camera-based surround capture system 14, that is to say the images provided by the camera-based surround capture system 14. The sensor information from the surround sensor 22 and the camera-based surround capture system 14 is processed together in order to register the at least one obstacle 32. In the process, fusion of the sensor information of the surround sensor 22 and the camera-based surround capture system 14, optional per se, is carried out.

The at least one obstacle 32 can be established directly on the basis of the sensor information from the surround sensor 22 together with the camera-based surround capture system 14. Alternatively or in addition, a surround map may be generated on the basis of the sensor information and said surround map serves as a basis for establishing the at least one obstacle 32.

Step S180 relates to a representation of the at least one obstacle 32 in a third overlay plane which covers the surround 16 of the vehicle 10.

In the first exemplary embodiment, which is depicted in FIG. 2, the representation of the at least one obstacle 32 in the third overlay plane comprises a representation of boundary lines of the at least one obstacle 32. In this exemplary embodiment, the boundary lines merely mark the sides of the obstacle 32 facing the vehicle 10. Alternatively or in addition, the obstacles 32 can be represented by an area that is colored differently. In this case, there is the distance-dependent representation of the obstacles 32 with different colors that is dependent on the distance, in a manner not depicted in FIG. 2. In this exemplary embodiment, close regions of an obstacle 32 are represented using a red color, for example, while distant regions of the obstacle 32 are represented using a green color or using a black or gray color. Such a representation lends itself especially to regions that are no longer actively registered by the surround sensors. This can indicate to the user that this region was previously registered by one of the surround sensors but there no longer is active registration.

In the second exemplary embodiment, which is depicted in FIG. 3, a step of identifying the at least one obstacle 32 is carried out initially. This comprises a classification of the obstacles 32, for example in order to identify third-party vehicles, trees, persons, buildings, garbage cans or other obstacles 32. In the exemplary embodiments shown here, the obstacles 32 are third-party vehicles.

On the basis of the identification, a representation of the obstacle 32 is chosen in correspondence with the respective class used in the third overlay plane. In this exemplary embodiment, the obstacle 32 is represented in a top view in correspondence with the representation of the surround image 26. Alternatively, the obstacle 32 can be represented in a side view. Accordingly, the at least one obstacle 32 is represented on the basis of the identification.

In the third exemplary embodiment, which is depicted in FIG. 4, representation of the at least one obstacle 32 in the third overlay plane comprises a provision of a camera image of the at least one obstacle 32, as was recorded by the camera-based surround capture system 14. As a result, a realistic representation of the at least one obstacle 32 is generated. In this case, the camera image is preferably generated in a top view in correspondence with the representation of the surround image 26, or the camera image is projected into the top view. Alternatively, the camera image of the at least one obstacle 32 is generated in a side view on the basis of the images of the surround 16 of the vehicle 10 that were provided by the camera-based surround capture system 14. Consequently, the at least one obstacle 32 is visualized in the style of a representation as is used in the case of an adaptive bowl view for example. The side view is preferably generated without distortions or with reduced distortions, for the purposes of which appropriate image processing of the images from the camera-based surround capture system 14 is carried out.

Step S190 relates to the surround image 26 being overlaid with the first, second and third overlay plane. Within the scope of overlaying, available parts of the surround image 26 are placed or complemented by the information of the overlay planes, for example by way of a partly transparent overlay. In this case, it is not necessary for the surround image 26 to completely fill an image area. In this case, the surround image 26 is only complemented with image information of the overlay planes. In this case, the overlay planes may in principle be arranged in any sequence and possibly overlay one another. The surround image 26 overlaid thus may be output by way of the user interface of the vehicle 10 and be displayed to the vehicle driver.

By overlaying the overlay planes on the surround image 26 there is a combined representation of the surround 16, as perceived by the vehicle driver, together with the park information, which in this case relates to a position of the parking space 24 in the surround 16 of the vehicle 10.

### LIST OF REFERENCE SIGNS

10 Vehicle
12 Driving assistance system
14 Camera-based surround capture system
16 Surround
18 Processing unit
20 Data bus
22 Surround sensor
24 Target position, parking space
26 Surround image
28 Drivable area
30 Non-drivable area
32 Obstacle

1. A method of representing a surround of a vehicle, the vehicle having a camera-based surround capture system for capturing the surrounding of the vehicle for the purposes of moving the vehicle to a target position in the surrounding, the method comprising:
providing images of the surrounding of the vehicle using the camera-based surround capture system;
generating a surround image from a bird's eye view on the basis of the images of the surrounding of the vehicle provided by the camera-based surround capture system;
determining at least one target position in the surrounding of the vehicles;
representing the at least one target position in a first overlay plane which covers the surround of the vehicle; and
overlaying the first overlay plane on the surround image.

2. The method as claimed in claim 1, further comprising:
establishing a non-drivable area in the surrounding of the vehicle;
representing the non-drivable area in a second overlay plane which covers the surrounding of the vehicle; and
overlaying the second overlay plane on the surround image.

3. The method as claimed in claim 2, wherein the representation of the non-drivable area in a second overlay plane which covers the surrounding of the vehicle comprises a generation of a representation of the non-drivable area in a side view on the basis of the images of the surrounding of the vehicle that were provided by the camera-based surround capture system.

4. The method as claimed in claim 1, further comprising:
establishing at least one obstacle in the surrounding of the vehicle;
representing the at least one obstacle in a third overlay plane which covers the surrounding of the vehicle; and
overlaying the third overlay plane on the surround image.

5. The method as claimed in claim 4, wherein the representation of the at least one obstacle in a third overlay plane comprises a representation of boundaries of the at least one obstacle.

6. The method as claimed in claim 4, further comprising: identifying the at least one obstacle, wherein the representation of the at least one obstacle in a third overlay plane which covers the surrounding of the vehicle comprises a representation of the at least one obstacle on the basis of the identification of the at least one obstacle.

7. The method as claimed in claim 4, wherein the representation of the at least one obstacle in a third overlay plane which covers the surrounding of the vehicle comprises a provision of a camera image of the at least one obstacle.

8. The method as claimed in claim 4, wherein the representation of the at least one obstacle in a third overlay plane which covers the surrounding of the vehicle comprises a distance-dependent representation of the at least one obstacle.

9. The method as claimed in claim 4, wherein the representation of the at least one obstacle in a third overlay plane which covers the surrounding of the vehicle comprises a generation of a representation of the at least one obstacle in a side view on the basis of the images of the surrounding of the vehicle provided by the camera-based surround capture system.

10. The method as claimed in claim 1, wherein the determination of at least one target position in the surrounding of the vehicle and/or the determination of a non-drivable area in the surrounding of the vehicle and/or the establishment of the at least one obstacle in the surrounding of the vehicle is implemented taking account of the images of the surround of the vehicle that were provided by the camera-based surround capture system.

11. The method as claimed in claim 1, further comprising:
receiving sensor information from at least one lidar-based surround sensor, a radar sensor and/or a plurality of ultrasound sensors, which registers at least a portion of the surrounding of the vehicle,
wherein the determination of at least one target position in the surrounding of the vehicle and/or the determination of a non-drivable area in the surrounding of the vehicle and/or the establishment of the at least one obstacle in the surrounding of the vehicle is implemented taking account of the sensor information of the at least one further surround sensor.

12. The method as claimed in claim 1, wherein the generation of a surround image from a bird's eye view on the basis of the images of the surrounding of the vehicle that were provided by the camera-based surround capture system comprises a generation of a bowl view-type surround image.

13. The method as claimed in claim 1, wherein the representation of the at least one target position in a first overlay plane which covers the surrounding of the vehicle comprises a representation of a trajectory for moving the vehicle to reach the target position.

14. The method as claimed in claim 13, wherein the representation of a trajectory for moving the vehicle to reach the target position comprises a representation of an area the vehicle passes over when driving along the trajectory.

15. The method as claimed in claim 1, further comprising:
storing the images of the surrounding of the vehicle that were provided by the camera-based surround capture system,
wherein the generation of a surround image in a bird's eye view comprises a generation of at least one first area of the surround image on the basis of images of the surrounding of the vehicle provided by the camera-based surround capture system and at least one second area with stored images of the surround of the vehicle.

16. A driver assistance system for representing a surrounding of a vehicle, comprising:
a camera-based surround capture system for capturing the surrounding of the vehicle and a processing unit which receives images of the surrounding of the vehicle, wherein the driver assistance system is configured to perform the method as claimed in claim 1.
